(19) United States
(12) Patent Application Publication
(10) Pub. No.: US 2005/0261957 A1
(43) Pub. Date: Nov. 24, 2005

(54) Method for evaluating fitness for duty

(76) Inventors: David Fisher, Burnsville, MN (US); Sheridan Fenwick, Bonita Springs, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/103,661

(22) Filed: Apr. 12, 2005

Related U.S. Application Data
(60) Provisional application No. 60/561,340, filed on Apr. 12, 2004.

(51) Int. Cl. G06F 17/60

(52) U.S. Cl. 705/11

(57) ABSTRACT

A method for evaluation the fitness for duty of an employee is disclosed. The method for evaluating the fitness for duty of an employee, utilizing as parties an employer, a fitness for duty evaluation facilitator, an employer, and an Independent Examiner, comprising the steps of the fitness for duty evaluator facilitator: Having separate ownership from the employer and the employee assistance professional; utilizing the Independent Examiner to perform the fitness for duty evaluation; providing advanced training to the Independent Examiner; providing fitness for duty evaluation training to employee assistance professionals; providing fitness for duty evaluation training to the employer; providing fitness for duty evaluation education to the employee; providing quality assurance services; and utilizing a licensed professional to oversee the fitness for duty evaluator.

### CLAIM OF PRIORITY

The present application claims priority to U.S. Provisional Application 60/561,340 filed Apr. 12, 2004, which is incorporated by reference herein in its entirety.

### FIELD OF THE INVENTION

The present invention relates to a method for evaluating employees, and in particular, to a method or evaluating fitness for duty of employees.

### BACKGROUND OF THE INVENTION

Employees with psychological problems can reduce workplace productivity, cause acrimony, violence, and even death. According to the national Institute of Occupational Safety and Health, about one million workers are victims of workplace violence each year. The U.S. Department of Labor reports that homicide is the third leading cause of fatal occupational injury in the United States. The Society for Human Resource Management (SHRM) indicates that workplace murder is the fastest growing form of homicide.

Employers can be liable for employee behavior, if it can be demonstrated that the employer was negligent in its control of employees. Juries award multimillion-dollar judgments against employers and Employee Assistance Programs (EAPs, also referred to as “employer-paid professionals” are organizations that provide health care assistance to the employer or the employee) that fail to take appropriate action regarding impaired or dangerous employees. Further, under the Americans with Disabilities Act, federal courts have ruled that employers can be liable for hostile work environments. Consequently, it is imperative that employers and employer-paid professionals or organizations (EAPs) that provide health care assistance to the employer or the employee professionals have methods to maintain safe environments and protect staff from the impact of employees with psychological problems.

A Fitness for Duty Examination (FFDE) is an evaluation of an employee and the workplace. Methods used to carry out a FFDE include a psychological or psychiatric interview by a psychologist and/or a psychiatrist, the administration and interpretation of psychological tests, collateral interviews with employees' supervisors, co-workers, spouse or others, and an analysis of the workplace environment.

When a FFDE is needed, employers, doctors, employees, and EAP professionals currently face many obstacles. Some of the most serious of these occur when dual professional relationships are established between the parties involved in the FFDE. These parties include the doctor (i.e. the “Independent Examiner”) performing the FFDE, the employee requiring the examination, the doctor(s) previously providing treatment to the employee, and the EAP.

Stone (2000, pp. 134-135) describes the current state-of-the art in his book entitled Fitness for Duty. Principles, Methods, and Legal Issues. He describes problems with dual relationships as follows:
“There are other considerations, in addition to competency issues, that should enter into the decision to undertake a particular FFD [Fitness for Duty] evaluation. The foremost of these involves the relationship between the provider [i.e. the doctor performing the FFD evaluation] and all parties in an FFD case that is likely to influence the outcome or be perceived as influencing the outcome. The key issue here is the actual and perceived independence of the provider and the neutrality of the evaluation. Where one or the other party has some relationship with the provider external to the evaluation (e.g., they are personal friends or neighbors), independence and neutrality can be compromised. This is sometimes referred to as a dual relationship.
Looking at the first such dual relationship, consider a situation in which a provider is asked to perform an FFD evaluation of an employee whom he had seen previously as a patient (or client). This situation is not rare, particularly in rural settings where there may be few mental health providers. It also occurs in industrial settings in which the Employee Assistance Program (EAP) is asked to undertake an FFD evaluation of a former client. The most frequent instance, however, of such a situation is one in which an employer asks a treatment provider to provide a letter certifying that a patient is fit for duty or ready to return to work.

All these instances involve a dual relationship, a situation that is incompatible with the independence and neutrality of an FFD evaluation. That is, an FFD evaluation should be an effort to represent the interests of all stakeholders described in earlier sections, including employer, co-workers, citizens, as well as the employee himself. When the provider has an ongoing or prior special relationship with an examinee, the interests of the examinee typically become paramount. Indeed, they should become paramount if the examinee is or has been a patient of the provider, as the obligation is to the patient and not the employer, shareholders, or co-workers. There are several issues related to such a dual relationship that merit consideration:
1. Any information previously obtained by the provider as a treating professional (therapist, psychologist, physician. etc.) for the person now being examined in an FFD evaluation was obtained as a confidential communication within a therapeutic context. Using that information within the FFD context, in which an employee's interests are not central, would appear to violate that confidentiality.
2. Even though a patient's signed waiver might legally overcome the issue of loyalty, providers will tend to keep their patient's interest central, and thus they cannot provide an independent evaluation of an employee.
3. Mental health treatment providers typically have limited sources of data, particularly those who are exclusively or primarily treatment providers. As noted in the chapter on FMLA, when they provide an FFD letter clearing the employee to return to work, they seldom have the entire picture, as their perspective is typically that of the employee. In the absence of additional (perhaps contradictory) information and consistent with the helping role, the unbalanced data create a tendency to honor the employee's interest in returning to work with a finding that he is fit for duty . . . . ”
   Stone (2000, pp 136-137) continues:
“There are other circumstances in which a physician or therapist may feel an obligation to intervene (under a duty to warn theory). Such an obligation might arise if the provider suspected that a patient-employee represented a danger to himself or others . . . . With such concerns, it may be appropriate to notify an employer with a limited statement regarding the patient's potentially dangerous behavior (and in that context, such a wording has an FFD quality). However, in this author's opinion, it would violate a prohibition against dual relationships if the treating professional were to perform a full FFD evaluation of this patient under these circumstances.
On the other side of the dual relationship picture, what about a special relationship between the provider and employer? This can be more subtle than the matter of a dual relationship involving provider and employee. In part, this is because the provider is typically paid by the employer, either as someone on the employer's payroll or as an external consultant to the employer. Whether on the payroll or as an outside consultant, the provider will, to varying degrees, be dependent on the employer for his livelihood. There will certainly be a temptation to satisfy the employer's perceived needs on the part of most providers . . .
In summary, dual relationships create insurmountable problems in almost every FFD case, and they certainly are not likely to bear up under scrutiny. Neither party, the employee or the employer, is obtaining a fair, independent evaluation when the provider has significant past or current obligations to an employee or employer.” (Italics added)

Stone's description of the “insurmountable problems” that occur in “almost every FFD case” highlights the need for an alternative to current FFDE methods.

The Council on Accreditation (COA) is a national body responsible for setting the professional standards by which EAPs must abide to receive its professional accreditation. Currently, the COA does not specify methods that ensure high quality FFDEs.

The Employee Assistance Professionals Association's (EAPA) is a national professional body that sets standards for EAPs. In the EAPA Code of Ethics, EAPs are instructed to avoid conflicts of interest. These conflicts frequently occur when dual relationships are established. However, this ethical code does not provide EAPs with methods sufficient to conduct FFDEs in a manner that prevents dual relationships from occurring.

Further, while the American Psychological Association (2002) has described ethical principles and conduct for psychologists, it does not specifically establish methods for psychologists to follow when conducting FFDEs. In sum, there is currently no set of commonly accepted professional methods governing the oversight of FFDEs in an ethical and scientifically-sound manner.

The most serious problems resulting from state-of-the art FFDE methods are listed below.
1. Formal and detailed databases containing useful information about Independent Examiners often do not exist, which otherwise provide information to assist in the selection of Independent Examiners
2. The limited numbers of health care providers in rural (and other) areas who are trained to perform FFDEs frequently results in poor quality FFDEs.
3. Most Independent Examiners have unique payment, billing and cancellation policies, which may confuse the employer and the EAP, and can result in unreasonable expenses for the employer and the EAP.
4. Poor and inconsistent assessment methods result in poor quality FFDEs, thus compromising fairness and objectivity. Limited information exists about how to formulate FFDE referral questions
5. Currently, insufficient methods exist to train doctors to a) formulate opinions, b) to convey opinions in a manner useful to the employee, employer, and the EAP, and c) to understand privacy issues as they relate to FFDEs.

The employee is the person evaluated in a FFDE. It is the employee's responsibility to cooperate with the FFDE process in accordance with company and union rules. This individual is not referred to as a “patient” in the context of a FFDE; because doing so would imply that the Independent Examiner(s) is/are treating, rather than assessing, the employee. For the purposes of this application, the term “employee” could also mean a job applicant, volunteer, student, military personnel, business owner, government official, defendants in court systems, or plaintiffs in civil litigation.

The employer is the entity that employs the person to be evaluated and pays for an FFDE. It is solely the employer's responsibility to decide whether to refer an employee for a FFDE. This decision is based upon the employer's policies regarding, for example, declines in job performance, threats, and absences. To facilitate the evaluation, the employer should provide complete and accurate information to the Fitness For Duty Evaluation Facilitator, the EAP, and the Independent Examiner about employee behavior and responsibilities on the job. The employer is responsible for paying for the FFDE. However, to further support the independent nature of the evaluation, payment should usually be made through and to the FFDE Facilitator. The employer may contact the FFDE Facilitator directly or through their EAP, if an EAP is involved. Employers are the only ones that may make decisions regarding retaining or dismissing employees. For the purposes of this application, the term “employer” could also mean a supervisor hiring new employees or volunteers, volunteer supervisors, teachers or school administrative personnel, military personnel, business owners, government officials, attorneys, judges, or mediators.

An Employee Assistance Program (EAP) is an entity, hired by an employer, that assists employees and their families with personal and work-related problems. For the purposes of this application, the term “Employee Assistance Program” could also mean a volunteer organization, employment/job search firm, military personnel, business owners, government agencies, attorneys, judges, student placement service, or another type of company providing services to the government.

Employee Assistance Professionals are frequently hired by employers to provide support services and assistance to employees. Within the context of a FFDE, Employee Assistance Professionals' roles might include informing the employer about the potential benefits of an FFDE, recommending a FFDE Facilitator and/or coordinating the FFDE with the FFDE Facilitator. EAP professionals commonly help employers learn the differences between evaluations done for treatment (often through the EAP), from those needed for medical/legal (i.e. “forensic”) purposes such as FFDEs. The EAP professional can also help with implementing the Independent Examiner's recommendations. The EAP is not responsible for determining the severity of employee psychological problems, the risks they may pose, or making administrative decisions for the employer related to the examination findings. FFDEs can take place without the involvement of an EAP.

For the purposes of this application, the term “Employee Assistance Professional” could also mean an individual working in an employment/job search firm, student placement service, and government officials, or another company providing services to the government.

The FFDE Facilitator is an entity independent of the employer, the EAP and doctors (i.e. the “Independent Examiners”), that participates in the FFDE process. As an independent entity it shares no co-ownership with, and has no fiduciary duties to, the Independent Examiner, employer, EAP, or employee. Further, the only financial relationship it has with the employer or the EAP is that one or more of them are responsible for paying the FFDE Facilitator for FFDEs.

The FFDE Facilitator's independence from the other parties protects the EAP, the “Independent Examiner” and the employer from actual, potential or perceived conflicts of interest. The FFDE Facilitator also protects the other entities by using its experience in selecting and training Independent Examiners, knowledge of the best evaluation methods, and other quality assurance services to ensure high quality FFDEs. The FFDE Facilitator always enlists outside doctors, (i.e. “Independent Examiners”) for FFDEs, not its own employees to perform FFDEs. Further, it specializes in teaching the employer, the EAP, and the Independent Examiner about proper FFDE methods.

The Independent Examiner is a professional trained to assess mental health or physical problems in a medical/legal (forensic) context. This individual is often a psychologist or a psychiatrist with considerable experience in both medicine and medical/legal matters. The Independent Examiner has no significant financial ties with either the EAP or the employer, has no fiduciary relationship with these entities, and is not on the FFDE Facilitator's staff. Independent Examiners rely on objective psychological testing, and are trained to detect dishonesty. They are taught to write reports that withstand the scrutiny of court, and to avoid dual relationships. More than one Independent Examiner may be needed to perform each FFDE. For the purposes of this application, the term “Independent Examiner” could also mean a job coach, vocational expert, volunteer, government official, judge, or attorney.

A doctor is an individual, such as a psychologist or psychiatrist, possessing a doctoral degree from an accredited institution such as a university or professional school. A doctor does not necessarily qualify as an Independent Examiner. A doctor may have direct financial, treating, professional, or other relationships with any party involved in a FFDE. For the purposes of this patent, the term “Doctor” could also mean a job coach, vocational expert, volunteer, government official, judge, or attorney.

### OBJECTS AND SUMMARY OF THE INVENTION

It is an object of the present invention to provide a system and method of evaluating fitness for duty that protects the fitness for duty evaluation facilitator, the Independent Examiner, the employee, the employer, and the employee assistance program from legal and ethical challenges, and to avoid problems resulting from poor quality FFDEs.

It is a further object of the present invention to provide a system and method of evaluating fitness for duty that promotes fairness and objectivity by insulating the EAP, employer, employee and Independent Examiner from each other.

It is yet a further object of the present invention to provide a system and method of evaluating fitness for duty that instructs employers, EAP professionals, and Independent Examiners to follow FFDE procedures that best safeguard all parties from legal and ethical challenges, dangerous workplaces, reduced employee productivity, and other legal consequences and ethical problems that may otherwise result from poor quality FFDEs.

In accordance with a first aspect of the present invention, a novel system and method of evaluating fitness for duty is provided. The novel system and method includes protecting the employer and employee by by a) requiring Independent Examiners to have competence in forensic assessment, b) helping ensure that FFDEs follow standardized assessment protocols, c) insulating the EAP, the employer, the employee, and the Independent Examiner from each other, d) helping ensure that evaluations are completed in a fair, timely and scientifically sound manner, e) having doctoral level FFDE Facilitator staff teach and/or consult as necessary with all parties, f) following security requirements consistent with state and federal laws, rules, and regulations g) teaching employers and EAPs how to identify some at risk employees, and h) making advanced FFDE training available to Independent Examiners and others.

In accordance with another aspect of the present invention, a novel system and method of evaluating fitness for duty is provided. The novel system and method includes separating each of the other parties from each other. Insulating these parties is accomplished when the FFDE Facilitator performs many of the tasks that the other involved parties would otherwise be forced to perform directly with each other. For example, if the FFDE Facilitator were not available, Employee Assistance Program personnel or employers might select, pay, and supervise the Independent Examiner. Instead, the FFDE Facilitator is available to carry out these functions by separating the parties, thus reducing the likelihood and appearance of dual relationships and promoting fairness and objectivity. When an FFDE Facilitator is not utilized in a FFDE, employers commonly discuss their employees' behavior and problems in detail with the EAP. However, a FFDE Facilitator permits the employer and the EAP to have limited (or no) contact with each other regarding the FFDE, thus protecting the existing non-forensic relationships between the EAP, the employee, and the employer.

In accordance with yet another aspect of the present invention, a novel system and method of evaluating fitness for duty is provided. The novel system and method includes include teaching a) Independent Examiner how to perform an FFDE competently, b) the employer how to properly identify at-risk employees, phrase referral questions and manage the FFDE in other respects, c) consulting with an employer-paid professional or organization on the appropriateness of a fitness for duty examination of an employee, and d) the employee about privacy issues. Further, the FFDE Facilitator collaboratively consults with the EAP, employer, Independent Examiner, and occasionally, the employee, about other professional issues related to the FFDE.

### BRIEF DESCRIPTION OF THE DRAWING

The foregoing summary, as well as the following detailed description of a preferred embodiment of the present invention will be better understood when read with reference to the appended drawing, wherein:

FIG. 1 is a partial flow diagram illustrating the current preferred embodiment of the FFDE Facilitator in accordance with the present invention.

### DETAILED DESCRIPTION OF THE PREFERRED EMBODIMENT

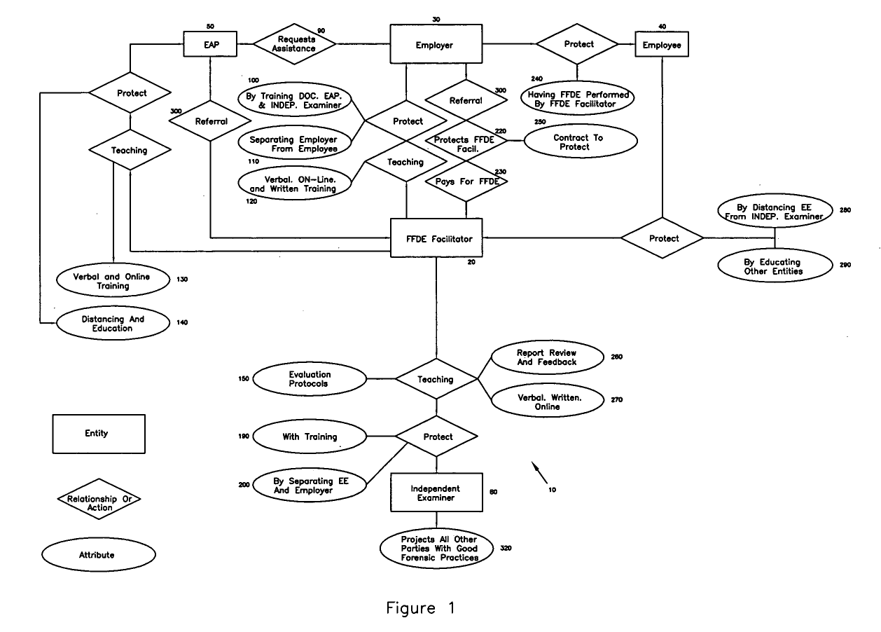

Referring now to FIG. 1, the current preferred embodiment of the present invention is illustrated. It represents the unique combination of services, as well as business and professional relationships established by the FFDE Facilitator 20.

Among other things, FIG. 1 illustrates the relationship between the employer 30 and the FFDE Facilitator 20. It indicates that the FFDE Facilitator 20 consults with and teaches 60 the employer 30 using training 120 designed for the employer 30 and consultative services delivered verbally, on-line, or by other means. Further, the FFDE Facilitator 20 protects 70? the employer 30 by insulating 110,140,200,250 the employer 30 from all other parties, as well as by enhancing the quality of the assessment with methods such as training the Independent Examiner 80 and the Employee Assistance Program 50 professionals. (FIG. 1 also indicates that the employer 30 may refer the employee 40 to the FFDE Facilitator 20). The employer 30 legally protects the FFDE Facilitator 20 with a contract 235 that includes language binding the employer 30 to protect and indemnify the FFDE Facilitator 20. FIG. 1 indicates that the employer 30 pays for the FFDE.

Furthermore, FIG. 1 also illustrates the FFDE Facilitator's 20 three primary goals. These three goals are to, 1) protect the fitness for duty evaluation facilitator, the Independent Examiner 80, the employee 40, the employer 30, and the employee assistance program from legal and ethical challenges, and to avoid problems resulting from poor quality FFDEs , 2) providing a system and method of evaluating fitness for duty that promotes fairness and objectivity by insulating the EAP 50, employer 30, employee 40, and Independent Examiner 80 from each other and 3) instruct employers 30, EAP 50 professionals, and Independent Examiners 80 to follow FFDE procedures that best safeguard all parties from legal and ethical challenges, dangerous workplaces, reduced employee productivity, and other legal consequences and ethical problems that may otherwise result from poor quality FFDEs. The methods used to achieve them, are unique to the FFDE Facilitator 20.

The FFDE Facilitator 20 is an organization that includes:

1) Medically/legally-trained (preferably at a doctoral-level) staff skilled in directing FFDEs
2) Professional staff trained to perform other FFDE duties, such as helping select the Independent Examiner 80, schedule the FFDE, send and receive documentation pertaining to the FFDE, and collect basic information about the circumstances necessitating a FFDE.
   Step-by-step methods:
1. Preferred relationships between the parties:
   Preferred Scenario 1: The Employer 30 Refers 210 the Employee 40 to the FFDE Facilitator 20 that, in Turn, Performs a FFDE with an Independent Examiner 80

Here, the EAP 50 is not involved in the FFDE process. Therefore, the EAP 50 might have limited or no legal risks, depending on the circumstances. The employer 30 and the Independent Examiner 80 are also insulated by the intervening FFDE Facilitator 20, therefore likely providing protection 70? from perceived and actual conflicts of interest and undue influence.

An additional method of insulating parties from each other is to keep the Independent Examiner 80 uninformed of the employer's 30 identity.

Preferred Scenario 2: The Employer 30 First Refers the Employee 40 to its own EAP 50. The EAP 50 then Asks the FFDE Facilitator 20 to Have an Independent Examiner 80 Perform the FFDE on the Employee 40.

All concerned can be better protected when the FFDE Facilitator 20 (recommended by the EAP 50) selects an external Independent Examiner 80 that is not employed by the employee's 40 company, the EAP 50, or the FFDE Facilitator 20. The employer 30 neither chooses the Independent Examiner 80, nor the Independent Examiner's 80 clinic, thus increasing the potential for a FFDE truly independent of undue employer 30 influence.

This approach best insulates the employer 30 from the Independent Examiner 80, and results in the least risk for both the employer 30 and the employee 40. The EAP 50 also has considerable protection in this arrangement, because it is separated from the Independent Examiner 80 by the intervening FFDE Facilitator 20.

Steps the FFDE Facilitator 20 Follows to Facilitate a FFDE:

1. An Employer 30 or EAP 50 contacts 210 the FFDE Facilitator 20 either with a face to face meeting, a telephone call, e-mail, or by other means regarding an employee 40 perceived as having behavioral and/or psychological problems. These behaviors and problems include those described in every diagnostic category included in the Diagnostic and Statistical Manual of Mental Disorders-IV (American Psychiatric Association, 1994). The employer 30 is responsible for initially identifying the potentially at-risk employee 40. However, the employer 30 may seek counsel from a FFDE Facilitator 20 and/or the EAP 50 to confirm that the employee's 40 behavior warrants a FFDE.
2. Two of the FFDE Facilitator's 20 staff (or the FFDE Facilitator's 20 independent contractors) obtain intake/referral 300 information. One of these individuals can be a person without an advanced professional degree, who is trained to take relatively basic information, such as names, addresses, and general descriptions of problems from the employer 30 or EAP 50 professional. The preferred methods of contact are either in person or by telephone, but such information can be exchanged by other means.

The individual who is typically employed by the FFDE Facilitator 20, who does not need to possess an advanced professional degree, can obtain information about and responses to following topics/questions:
Referral 300 Source (employee's 40 company and phone number)
Basic description of workplace behavior of concern, and relevant medical information
The names of the employee's 40 past or current psychiatrist, psychologist, and/or counselor(s)
The number of years the employee 40 has worked with his/her employer 40
Whether the employee 40 made direct threats towards him/herself or to others
Whether the employee 40 made any indirect threats towards him/herself or to others
Whether the employee 40 has a history of violence at work or elsewhere
Whether any threatened individuals been warned (if applicable)
If there is a history of conflict between employee 40 and his/her co-workers, supervisor(s), or others
Whether the employee 40 suffered or allegedly has suffered a traumatic experience on job or elsewhere
Whether the employee 40 is alleging harassment of any type
Whether the employee 40 has a history of experiencing conflicts or other difficulties with authority figures
Whether the employee 40 has a history of grudges at work or elsewhere
Whether the employee 40 has a history of arrest
Whether the employee 40 works in a safety-sensitive position
Whether the employee's 40 self-reports of his/her behavior are consistent with those of his/her supervisor or others
3. The second individual obtaining intake information for the FFDE Facilitator 20 is an employed (or sub-contracted) professional, such as a psychologist or psychiatrist, who reviews specifics of the case with the client in person, over the telephone, by mail, the Internet, or by other means. This is an in-depth exchange about the problems likely exhibited by the employee 40. The preferred method of exchanging this information is either in person or by telephone. During this initial consultation with an employer 30 and/or the EAP 50 professional, the psychologist or psychiatrist first covers most or all of the information listed in step #2 immediately above, but does so in more depth than was done by the first FFDE Facilitator 20 staff (or subcontracted) individual in step #2 above.
4. The FFDE Facilitator's 20 psychologist or psychiatrist then reviews and discusses the FFDE Facilitator's 20 suggested referral 300 questions with the employer 30 or EAP 50. These questions might be accepted, modified, or, deleted, according to the wishes of the employer 30, the EAP 50 and/or the FFDE Facilitator 20. The purpose of this discussion is to determine the questions that, when answered by the Independent Examiner 80, would best assist the employer 30 and/or the EAP 50 by addressing their concerns about the employee 40. The following are illustrative of potential referral 300 questions:
1. Accepting that it is usually impossible to predict violence with confidence, is there evidence at this time that this employee 40 presents an increased physical risk (compared to the general population) to him/herself or others at the workplace?
2. (If applicable) What is the nature of the potential harm?
3. (If applicable) Is there anything we could do that might reduce this threat? If so, please explain.
4. Did you find any psychiatric problem that would likely prevent this employee 40 from safely performing required tasks at work?
5. Please suggest a treatment or educational plan (if appropriate). Please give a detailed response and specify modality, frequency, and content in lay terms. Please be sure the employer 30 has enough information from your response to proceed with a return to work plan. If no educational plan or treatment is appropriate, please explain.
6. Do you recommend additional psychiatric/psychological assessment for this employee 40? If so, why? (Please consider assessment by a psychologist/psychiatrist, including neuropsychological evaluation).
7. Do you have any suggestions to help our management work with him/her effectively?
8. Could changes in this employee's 40 work environment be beneficial?
9. If you recommend any time off from work, please state:
   a. Whether leave would be continuous or intermittent
   b. When it would be required
   c. The duration of the leave
10. If time off work is recommended, is it for purposes of facilitating treatment and/or is it because it is not possible for the employee 40 to perform work tasks due to psychological/psychiatric problems?
11. Are there any future signs that management might notice that would indicate the need for additional assistance or further evaluation?
   Building disclaimers into the referral 300 questions as above reminds the employer 30, the Independent Examiner 80, and the EAP 50 of the limitations of behavioral assessment methods, and likely provides legal protection to all parties.
   5. The Intake Consultation with the FFDE Facilitator's 20 doctoral level professional staff or sub-contractor also may:
a) confirm that an evaluation may be warranted.
b) determine what type (e.g. psychiatric, psychological, brief, lengthy, etc.) of evaluation might best respond to employer 30 and/or EAP 50 questions.
d) determine if emergency treatment is obviously necessary or if they have an obvious duty to warn and/or protect other individuals.
e) teach the employer 30 and/or the EAP 50 about insulating themselves from each other, as described above.
f) inform the employer 30 and/or the EAP 50 about the anticipated costs of the FFDE.
g) direct the employer 30 to other helpful educational materials related to FFDEs.
h) teach the employer 30 and EAP 50 about what they can expect to learn and achieve by having a FFDE completed.
l) to discuss how the how the FFDE Facilitator 20 will send materials containing confidential medical information by facsimile to other parties (e.g. the employer 30, EAP 50, and the Independent Examiner 80) in a manner consent with federal, state, and local laws and regulations, and applicable professional standards of practice.
   6. The employer 30 and/or EAP 50 may be directed to the FFDE Facilitator's 20 FFDE educational materials 120. These may be made available on-line, via telephone, video conference, and educational conference and/or by other methods. This notification is sent by mail, in person, via the Internet, or by other methods. Educational materials typically include information about the following topics:
1. Introduction (A general introduction about the need for FFDEs)
2. Definition and circumstances appropriate for FFDEs. Methods to situations requiring FFDE assessments.
3. Roles of the different parties involved in the FFDE
4. Avoiding Conflicts of Interest
5. EAP 50 Participation in the FFDE
6. Writing Referral 300 Questions
7. The FFDE Facilitator's 20 role and methods
8. Recommended criteria for selecting the Independent Examiner 80
9. Informing the Employee 40 About the FFDE
10. FFDE Evaluation Protocol
11. FFDE Report Standards
12. What might be done by the employer 30 and/or EAP 50 after the FFDE
13. References to relevant documents
14. Participant Examination (a test or examination of the participant's knowledge or skills regarding FFDEs).
   7. The employer 30 and/or EAP 50 may be sent a) a request for any necessary additional information such as the employee's 40 job description b) a request for instructions about how the Independent Examiner 80 may contact the employee's 40 coworkers, supervisors, and/or others, c) requests for information about the nature of the FFDE process, d) medical records and e) a contractual agreement. The contractual agreement 235? describes the FFDE process to the employer 30, and binds the employer 30 to indemnify and protect 220 the FFDE Facilitator 20 from subsequent legal action.
   8. Selection of Independent Examiner 80, scheduling of appointment.
   Using a computerized database or other methods, the FFDE Facilitator 20 searches for (a) potential Independent Examiner(s) 80. To find the most qualified individual(s), the FFDE Facilitator 20 considers potential Independent Examiners' 80:
proximity to examinee
professional qualifications
professional specialties
fees
work quality,
experience administering and interpreting psychological testing
availability
responsiveness to written and verbal inquiries
malpractice insurance
history of professional infractions, if any
existing and potential conflicts of interest
other relevant information
   9. The FFDE Facilitator 20 uses its (usually computerized) database The (usually) computerized database, typically assembled by the FFDE Facilitator 20, includes information about current and potential psychologists, psychiatrists, and other healthcare professionals. Information about these professionals includes:
   1. Name
   2. Address
   3. Telephone, and facsimile numbers
   4. Professional degrees obtained
   5. e-mail address
   6. web-page address
   7. professional degrees
   8. history of disciplinary or other professional actions
   9. specialties
   10. fees
   11. Information about their existing professional and contractual relationships pertinent to the FFDE.
   12. subjective and objective ratings and subjective comments of the quality of their past psychological/psychiatric evaluations, if any
   13. test scores from professional training
   14. malpractice insurance information
   15. notes about their office methods
   16. indication about their contractual status with the FFDE Facilitator
   17. information about their professional reputations and credibility
   18. curriculum vitae
   19. license
      10. From time to time, doctors contact the FFDE Facilitator 20 for instructions about how to join the FFDE Facilitator's 20 panel of Independent Examiners 80. When this occurs, the FFDE Facilitator 20 sends doctors written instructions about how to join the FFDE Facilitator's 20 panel, an Independent Contractor agreement, as well as an inquiry about the doctor's professional fees. An alternate method is for the prospective Independent Examiner 80 panel member to obtain these materials from the FFDE Facilitator's 20 website. The FFDE Facilitator 20 may credential new Independent Contractors at any time. The FFDE Facilitator 20 may also solicit new experts at its discretion to expand its network of Independent Examiners 80.
      11. Depending on the FFDE circumstances, including employees' 40 mental health and medical diagnoses, employers' 30 concerns, and other factors, the FFDE Facilitator 20 will select one or more Independent Examiners 80 to perform each evaluation. Typically, two Independent Examiners 80 are selected if one of them does not have all professional skills necessary to perform a comprehensive FFDE.
      An example of a situation where two Independent Examiners 80 might be needed in this manner is when: a) one of the Independent Examiners 80 has the assessment skills to perform a diagnostic examination with the employee 40 and collateral interviews, but b) is not able to skillfully administer and interpret psychological tests. Here, the FFDE Facilitator 20 would likely recruit a second Independent Examiner 80 to perform the psychological testing.
      Another example is: a) an employee 40 has two different problems that cannot both be adequately evaluated by the same Independent Examiner 80. An employee 40 suffering both from hallucinations and chronic back pain illustrates this type of situation. One Independent Examiner 80 might have skills to evaluate hallucinations, but not chronic pain. Therefore, a second Independent Examiner 80 would be necessary to assess the psychological impact of chronic back pain.
      12. Whenever possible, the FFDE Facilitator 20 ensures that the potential Independent Examiners 80 have no prior contracts, professional agreements, or fiduciary relationships that might jeopardize the FFDE process.
      b 13. When two Independent Examiners 80 are utilized for the same FFDE, the FFDE Facilitator 20 frequently selects one Independent Examiner 80 to perform all or most components of the evaluation, with the exception of the psychological testing. This “first ” Independent Examiner 80 will (e.g.) perform the direct interview/examination of the employee 40, make collateral interviews with others who know the employee 40, give feedback to the employer 30, and write the final FFDE report, which consists primarily of responses to the employers' 30 referral 300 questions. This first Independent Examiner 80 may not be trained to perform or interpret psychological testing. This commonly occurs when this first Independent Examiner 80 is a psychiatrist.

In these cases, the FFDE Facilitator 20 chooses a “second” Independent Examiner 80 solely or primarily to perform psychological testing on the employee 40, interpret those test results for the first Independent Examiner 80 (often the psychiatrist), deliver those test results to the FFDE Facilitator 20 and to the first Independent Examiner 80, and rarely send them to the employer 30 and/or the EAP 50. The first Independent Examiner 80, who does not perform the psychological testing, utilizes those test psychological results to form opinions about the employee 40 examined with the FFDE.

14. The “second” Independent Examiner 80 who performs psychological testing is selected using many or all of the same criteria used to select the first Independent Examiner 80 described above. However, this second Independent Examiner 80 will have expertise in (e.g.) the administration and interpretation of the psychological test(s) administered to the employee 40. The second Independent Examiner 80 (who performs psychological testing) is sent a form which describes the purpose of the testing, the eventual use of test results, general or specific test referral 300 questions, and other requirements 150 for the testing or for that Independent Examiner's 80 test report. Test materials are exchanged between the two examiners via facsimile, e-mail, courier, with a postal service, or by other methods, and the first expert actually administers the test (usually a paper and pencil test). Typically, the FFDE Facilitator 20 requires the services of fewer testing Independent Examiners 80 than Independent Examiners 80 who directly examine employees 40. One testing Independent Examiner 80, operating from one location, may perform these testing services for other Independent Examiners 80 located at diverse geographic locations.

15. When selecting a new Independent Examiner 80, the FFDE Facilitator 20 will request information about potential Independent Examiners' 80 credentials, practices, and experience. The information typically requested is listed above in items 9 and 10.

16. As needed, the FFDE Facilitator 20 contacts new potential Independent Examiners 80 by e-mail, facsimile, or by telephone. The FFDE Facilitator 20 may send (by one or more of a variety of methods) this potential Independent Examiner 80 a request for information to assist in verifying the potential Independent Examiner's 80 credentials, experience, reputation, and other aspects of his/her professional history.

17. The FFDE Facilitator 20 will contact the potential Independent Examiner's 80 malpractice insurer (by one or more of a variety of methods), with approval from the Independent Examiner 80, to confirm that that doctor has sufficient malpractice insurance coverage, considering the specifics of the case.

18. When sufficient time has elapsed that would necessitate a re-verification of an Independent Examiner's 80 credentials, the FFDE Facilitator 20 might deliver a letter to the Independent Examiner 80 requesting that the Independent Examiner 80 provide updated and/or additional information (as above) to the FFDE Facilitator 20 to ensure that the Independent Examiner's 80 credentials are sufficient to perform additional FFDEs.

19. During the process of verifying potential Independent Examiner's 80 credentials, the FFDE Facilitator 20 might send the Independent Examiner 80 a form to sign, giving permission for the malpractice insurer to release information about the Independent Examiner's 80 history of malpractice claims to the FFDE Facilitator 20.

20. The FFDE Facilitator 20 may also check the National Practitioner Databank, or similar resources for any claims/disciplinary or court actions/sanctions listed against the potential Independent Examiner 80.

21. Before providing consultation services, potential Independent Examiners 80 sign an Independent Contractor agreement. This contract is designed to help the FFDE Facilitator 20 recruit a highly qualified group of psychologists, psychiatrists, and other professionals. Provisions of this contract include the establishment of a contractor/subcontractor relationship between the FFDE Facilitator 20 and the Independent Examiner 80, methods for the Independent Examiner 80 to follow when performing FFDEs, payment arrangements, malpractice insurance requirements, use of FFDE Facilitator's 20 name, symbols, and service marks, non-compete language, and various other FFDE Facilitator 20 expectations for the Independent Examiner's 80 professional conduct.

22. If the Independent Examiner 80 does not respond to the FFDE Facilitator's 20 requests for any credentialing materials, they are sent an urgent request for this material by one of a variety of methods.

23. After the doctor has fulfilled the FFDE Facilitator's 20 requirements to become an Independent Examiner 80, the doctor is notified by fax, telephone, e-mail, or by other means) of his/her status as an Independent Examiner 80.

24. Prior to, or shortly after, agreeing to complete an examination, the Independent Examiner(s) 80 is/are sent one or more letters instructing them about how to receive training 190 designed for Independent Examiners 80 on-line or by other means such as by telephone, video conference, in-person discussions, educational conferences in psychological/psychiatric evaluation methods. (If the Independent Examiner 80 or examiners have already taken this training, this step is omitted.) This training 190 includes information about the following topics:

Section 1: A Foundation—Some Information About Fitness for Duty Evaluations
Determining fitness for duty:
Functionality, Functional Capability, Assessing Dangerousness and
Malingering/exaggeration
Informed Consent and assessing the workplace
Conflicts of Interest and other ethical issues, and privacy
Section 2: Writing the Fitness for Duty report
Activities of Daily Living, including those at work
Substantiating your conclusions
Conceptualizing behavior
Documenting the sources of your information
Discussing limitations of data
Common errors related to the use of psychological tests:
Terminology, and responding to referral 300 questions
Billing and legal issues, including duty to warn

Section 3: Avoiding Common FFDE Errors
Error #1: Confusing the needs of the employer 30 and EAP 50 with those of other entities, such as the employee 40, and health insurer.
Error #2: Confusing diagnosis with fitness for duty.
Error #3: Confusing symptoms with fitness for duty.
Error #4: Assuming the role of a treating doctor.
Error #5: Interpreting measures of personality and mood as measures of fitness for duty.
Error #6: Making conclusions about fitness for duty caused by physical illness

Before completing the FFDE Facilitator's 20 training materials 190?, most psychologists and psychiatrists do not possess a high level of professional knowledge about the topics above, and/or the preferred/optimum method for obtaining the highest quality FFDE. 320

25. Independent Examiners 80 who have successfully completed the on-line training 190 and examination may be invited to apply for certification as “Certified FFDE Independent Examiners 80.” Those Independent Examiners 80 who receive this certification are those whose reports consistently receive quality ratings within the top 20% of FFDE reports generated nationally or regionally.

This certification requires five or more years of post-doctoral experience performing FFDEs, specialty training in forensics, and a history of ethical practice confirmed by the Independent Examiner's 80 state licensing board. Finally, the applicant must score 90% or higher on the training program (given on-line or by other means) for Independent FFDE examiners.

The FFDE Facilitator 20 awards certificates of completion for those who successfully complete the training program. Many Independent Examiners 80 are able to submit this certificate, along with the course outline, for continuing education credit hours. The FFDE Facilitator 20 also delivers Certified FFDE Independent Examiners 80 a certificate recognizing their certification, and may give them preference when selecting Independent Examiners 80 to perform future FFDEs.

26. The FFDE Facilitator 20 may make specialized training in some psychological/psychiatric FFDE assessment methods available to other doctors who have not met the criteria necessary to become Independent Examiners 80.

27. The FFDE Facilitator 20 negotiates fees for the Independent Examiners' 80 professional services with those Independent Examiners 80.

28. After the Independent Examiner(s) 80 has(have) been selected, fees have been negotiated and an appointment is set, an estimate letter with pertinent appointment information is faxed to the employer 30 for approval. Further, this estimate contains an agreement binding the employer 30 to contact the Independent Examiner 80 only after receiving approval to do so from the FFDE Facilitator 20. Further, the employer 30 might be sent information 20? about FFDEs to forward to the employee 40. This information is designed to educate them about the FFDE process, including steps that are taken to protect them. It is possible for a FFDE Facilitator 20 to have a contractual relationship with an employer 30, so individual estimates are not needed on every evaluation.

29. The Independent Examiner(s) 80 is/are sent a letter confirming the appointment time(s), and urging them to complete on-line 270 or other training 270 designed for Independent Examiners 80.

30. The primary Independent Examiner 80 is sent a) an Employee 40 Consent form related to the FFDE Evaluation, and b) one or more Employee 40 Information Release forms for the employee 40 to sign prior to the FFDE. These forms describe the nature of the evaluation, the relationships between parties, and inform the employee 40 about issues such as the release of confidential medical information, and also serve to collect the employee's 40 consent to release the examination results to other parties, such as the employer 30 and the EAP 50.

31. The Independent Examiner(s) 80 is/are sent an assessment protocol 150, specifying some of the FFDE Facilitator's 20 expectations for the evaluation and report. These standards may include (but are not limited to):

INTRODUCTION/REASON FOR REFERRAL 300 with discussions related to the referral 300 question(s), the limits of confidentiality, the relationship with the employee 40 and other parties, and other documentation issues.

Disclaimers: Please add the following (or similar) disclaimers in the beginning of your report, as appropriate:
a) The reader should consider that it is usually not possible to confidently predict dangerous behavior in individual cases.
   Particularly in the area of risk assessment, psychological/psychiatric evaluation complements, but does not replace, a broad investigation of your employee 40 to verify the existence of potentially dangerous thoughts or behavior.
b) This evaluation is based on all information available at this time. However, additional information could result in this writer forming different conclusions.
c) While absolute conclusions cannot be made on the basis of this report, recommendations and conclusions are given with a reasonable degree of psychological accuracy (please don't say—“certainty”).
d) In addition to the records that were available for review, as indicated above, other records (e.g., medical, mental health, school, etc.) or collateral resources (e.g., family members, friends, employers 30,) may also exist, but were not available for review at this time. It is possible that information contained in those records could affect the conclusions contained in this report.

1.) MENTAL STATUS EXAMINATION AND BEHAVIORAL OBSERVATION (Do not include this section in your report)

2.) HISTORY OF PRESENT PSYCHIATRIC ILLNESS Please be sure to obtain a thorough social history in this section. (Do not include this section in your report)

3.) WORK-RELATED STRESSORS (Do not include this section in your report)

4.) VIOLENCE : (Do not include this section in your report)

5.) PRESENT MEDICAL LEAVE AND TREATMENT (Do not include this section in your report)

6.) CURRENT SYMPTOMS AND ACTIVITIES OF DAILY LIVING (Do not include this section in your report)

7.) FAMILY BACKGROUND (Do not include this section in your report)

8.) MEDICAL HISTORY (Do not include this section in your report)

9.) REVIEW OF MEDICAL RECORDS (Do not include in your report)

10.) EDUCATION/VOCATIONAL BACKGROUND (Do not include this section in your report)

11.) EVALUATING THE WORKPLACE SETTING

12.) ASSESSMENT TOOLS (Only briefly describe the tests/instruments you administered, but do not discuss the test results).

13.) TELEPHONE CONSULTATIONS WITH TREATMENT PROVIDERS

14.) COLLATERAL INTERVIEW WITH SUPERVISOR OR CO-WORKER or OTHER INDIVIDUAL. Collateral interview with a person of the Employee's 40 choosing for fairness and balance.

15.) PsyBar suggests that you ask the examinee for the name of somebody s/he would like you to contact for a collateral interview.

16.) ANSWERS TO SPECIFIC REFERRAL 300 QUESTIONS

32. Occasionally, the Independent Examiner(s) 80 is/are sent medical records that are not accompanied by other forms. Also, employees 40 may bring medical records to the FFDE, or the employee 40 may sign a release form allowing their treating doctors to deliver the records to the Independent Examiner 80.

33. The employer 30 typically informs the employee 40 of the appointment date, time, and other information, as necessary. Alternately, the FFDE Facilitator 20 or the EAP 50 may inform the employee 40 about these matters. The employer 30 or other party may recommend that the employee 40 bring his/her medical records to the FFDE.

34. On occasion, employees 40 have conflicts between their personal schedules and the time of the FFDE appointment. They also might have difficulties with transportation to the FFDE or be uncooperative. In such instances, the appointment can be rescheduled or cancelled by the employer 30 or the FFDE Facilitator 20.

35. The FFDE Facilitator 20 may facilitate the transfer of other information to the Independent Examiners 80. This might include employees' 40:

Medical records, including written report and opinions, psychological and medical test results, information regarding drug and alcohol use, abuse, dependence, and treatment, psychotherapy notes, medical treatment records, hospital records, psychological and psychiatric treatment and medical/legal records, x-rays or other imaging results, billing statements, pathology reports, EKG, progress notes, laboratory reports, dental records, operative reports, radiology reports, discharge summaries, emergency room reports, history and physical exams, diagnostic imaging reports, consultations, HIV/AIDS testing information, genetic testing information, and outpatient clinic records
Job description
Specifics of events causing the evaluation
The FFDE Facilitator's 20 Assessment/interview Outline 150
The employer's 30 referral 300 questions to the Independent Examiner 80
Video tapes of the employee 40 at work, home, or elsewhere
Audio tapes of the employee 40 at work, home, or elsewhere
e-mails to/from the employee 40
   36. FFDE Facilitator 20 arranges testing.
   Objective psychological testing has proven invaluable for identifying malingering and confirming/measuring cognitive deficits. Many years of research has conclusively shown that some objective tests measure psychiatric problems more accurately than can the most skilled psychologist or psychiatrist. For this reason the FFDE Facilitator 20 recommends psychological testing on virtually every case.

Tests commonly recommended include the most recent versions of commonly used psychological tests of neurological/neuropsychological status, interests, personality, mood, truthfulness, and job-related aptitudes.

37. There are several preferred methods for coordinating psychological testing for FFDE assessments.

a) One psychologist Independent Examiner 80 performs all assessment methods, including the interview and psychological testing.
b) A psychiatrist Independent Examiner 80 performs all assessment procedures, with the exception of the psychological testing. (Psychiatrists are seldom trained to administer and interpret psychological tests). A second psychologist Independent Examiner 80 in the same geographic area then administers and interprets the psychological testing, and provides those test results to the psychiatrist.
c) A psychiatrist Independent Examiner 80 may perform all assessment procedures, with the exception of the psychological testing. A psychologist in a different geographic area delivers test materials to the psychiatrist. The psychiatrist then administers the psychological tests, and sends the results (usually in the form of an answer sheet) to the psychologist. The psychologist then writes an interpretation of the test results and delivers that interpretation to the psychiatrist.
   38. The FFDE Facilitator 20 arranges a post-evaluation discussion (typically via telephone) between the primary Independent Examiner 80 and the employer 30.

The employer 30 and/or the EAP 50 professional may wish to learn the Independent Examiner's 80 initial impressions soon after the interview. In these situations, Independent Examiners 80 contact employers 30 by telephone, in person, or by another means, as soon as possible to discuss their initial findings and recommendations with the employer 30.

39. The employee 40 may be directed to the FFDE Facilitator's 20 FFDE educational materials 290. These may be made available on-line, via telephone, video conference, and educational conference and/or by other methods. This notification is sent by mail, in person, via the Internet, or by other means. Educational materials typically include information about the following topics:
1. Introduction (A general introduction about the need for FFDEs)
2. Definition and circumstances appropriate for FFDES.
3. Roles of the different parties involved in the FFDE
4. Avoiding Conflicts of Interest
5. EAP 50 Participation in the FFDE
6. The FFDE Facilitator's 20 role and methods
7. Criteria for selecting the Independent Examiner 80
8. FFDE Evaluation Protocol
9. What might be done by the employer 30 and/or EAP 50 after the FFDE
10. Discussion of employee 40 confidentiality and consent
11. References to relevant documents
   40. The Independent Examiner 80 prepares a draft FFDE report in his/her office, and then sends a draft of his/her report to the FFDE Facilitator 20 via facsimile, encrypted e-mail, or other means.
   Another method of report preparation is for the FFDE Facilitator 20 to provide a telephonic transcription service to the Independent Examiner 80, which allows the FFDE Facilitator 20 direct access to the draft report.
   41. The FFDE Facilitator 20 receives the Independent Examiner's 80 draft FFDE report. Preferably, this draft is transmitted by facsimile, a postal service, or by encrypted e-mail to the FFDE Facilitator 20.
   42. The FFDE Facilitator's 20 quality assurance panel, made up of licensed psychologists and/or psychiatrists, then reviews 260 the draft to ensure the employer's 30 referral 300 questions are answered and that any unnecessary confidential medical information is not described in the FFDE report. Medical information may be omitted if including it would violate state, federal, or local laws, rules, regulations, or generally accepted professional standards. The report reviewer might then suggest revisions to the Independent Examiner 80. These suggested revisions 260 commonly concern the topics covered in the employer 30/EAP 50 training materials 120 designed for employers 30 and employer 30-paid professionals or organizations that provide health care assistance to the employer 30 or the employee 40) the Ethical Principles of Psychologists and Code of Conduct (American Psychological Association, 2002), and all other relevant state-of-the art professional methods related to psychological and psychiatric assessment. The FFDE Facilitator's 20 quality assurance panel may be composed of FFDE Facilitator 20 employees, sub-contractors, or both. The FFDE Facilitator 20 may also omit identifying information, such as employee 40 and employer 30 names from draft reports, and suggest other changes, before they are sent to the quality assurance panel. The FFDE Facilitator 20 will never ask the Independent Examiner 80 to change his/her opinion.
   43. All reports are rated for quality 260 by doctoral-level professionals employed or subcontracted by the FFDE Facilitator 20, according to the following scale:
A=A report falling within the top 5% nationally, compared to national practice standards among all psychologists/psychiatrists.
B=A report falling within the top 6-20% compared to national practice standards among all psychologists/psychiatrists.
C=A report falling within the middle 40-70% compared to national practice standards among all psychologists/psychiatrists.
D=A report falling within the bottom 6-39% compared to national practice standards among all psychologists/psychiatrists.
F=A report falling within the bottom 5% compared to national practice standards among all psychologists/psychiatrists.
   Ratings of report quality are maintained by the FFDE Facilitator 20.
   44. The FFDE Facilitator 20 sends the critiqued report back to the Independent Examiner 80 by fax or by other means. These critiques/suggestions are sent to the Independent Examiner 80 so that they may incorporate them as he/she deems appropriate.
   45. If the report needs significant changes, the FFDE Facilitator 20 may give the Independent Examiner 80 the following or similar instructions 60,260,270:
“Dear Doctor: I suggest that you (again) refer to the educational materials we previously offered to you. These materials address most or all of the comments below. If you contact Mr./Ms. xxxx at our office, s/he will give you a coupon, allowing you to review these materials at no charge. Please note that we have been approved to offer continuing education credit for psychologists by (Accrediting organization's name here, such as the American Psychological Association).
   46. The FFDE Facilitator 20 asks Independent Examiners 80 to correct/amend/clarify their draft reports and furnish final signed reports to the FFDE Facilitator 20 in a timely manner. The reports can be transmitted via US mail, private delivery services such as Federal Express, encrypted e-mail, or by other means.
   47. The FFDE Facilitator 20 transmits the final FFDE report to the employer 30 and/or the EAP 50 by facsimile, encrypted or otherwise secure e-mail, postal service, or by other means.
   48. Occasionally, Independent Examiners 80 are asked for report addenda, after the final reports have been completed. The FFDE Facilitator 20 provides assistance obtaining addenda as necessary.
   49. The FFDE Facilitator s 20 reimburse Independent Examiners 80 for their professional services. If an Independent Examiner's 80 fees are reduced, either because of a late report or for other reasons, the FFDE Facilitator 20 relays this action to the Independent Examiner 80 by fax, telephone, or by e-mail.
   50. The FFDE Facilitator 20 provides additional counsel 60 to employer 30 or EAP 50 as needed.
   Employers 30 and EAP 50s often require additional assistance after they receive the final FFDE report. Common scenarios include situations where the employer 30:
a) does not understand terminology used in the FFDE report
b) requests that the Independent Examiner 80 respond to additional questions
c) believes an Independent Examiner 80 did not adequately respond to one or more referral 300 questions
d) has a complaint about the FFDE report or other FFDE methods
e) wants information about its legal obligations to release the FFDE report to an employee 40 or other entity 150.
f) requests a second FFDE on the same employee 40
g) has misplaced a report
h) has additional information for the Independent Examiner 80
i) faces a troublesome situation with a second employee 40
   51. All critical documents are stored by the FFDE Facilitator 20 in a protected archive in accordance with federal, state, and local regulations, as well as with other professional practice standards.
   52. After the FFDE is complete, the FFDE Facilitator 20 requests that the Independent Examiner 80 provide a) information about the Independent Examiner's 80 satisfaction with the evaluation process and b) suggestions for improvement to the FFDE assessment protocol.
   53. After the FFDE is complete, the FFDE Facilitator 20 requests that the EAP 50 and/or Employer 30 provide a) information about their satisfaction/dissatisfaction with the evaluation process and b) suggestions for improvements for FFDE methods.
   54. Ideally, the FFDE Facilitator 20 utilizes an Internet website. This website may contain the following features to educate 60,90,100,120,130,140,290 people about the FFDE's services, to provide continuing education, and for other purposes:
a. descriptions of the FFDE Facilitator's 20 services and goals
b. FFDE training may be delivered on-line (or by other means) for Independent Examiners 80, employers 30, employees 40 and EAP 50 professionals
c. links to other relevant educational websites
d. a description of the methods used when conducting FFDEs
   55. The FFDE Facilitator 20 may assist the employer 30 and/or the to EAP 50 identify at-risk employees 40, with training 100, 120 provided on-line, by post, in person, by video conference, or by other means.
   56. The FFDE Facilitator's 20 training provided on-line or by other means may have the following characteristics:
1) It is part of, or linked to, the FFDE Facilitator's 20 homepage
2) When the user goes to the training program, he/she is allowed to a) register as a new user, or b) log in with a previous password and user name. Further, here the user has access to a link that outlines each of the training programs available on that site. There is also a link to contact technical support in the event of technical difficulties. This initial page further offers potential doctor/customers information regarding the FFDE Facilitator's 20 accreditation by one or more agencies.
3) If the user chooses to register as a “new user” he/she may enter his/her first name, title, email address, user name, password, telephone numbers, address, highest degree obtained, number of years they have been in practice, the percentage of work that they do related to the type of online training for which they are registering, the number of relevant forensic/psychological/psychiatric evaluations that they have performed, and other credentials. Further, he/she is presented with a written document indicating the terms of use of the training website.
   Upon completion of all of the above materials and upon their acceptance of the terms of the user agreement, the user is directed to a webpage enabling them to: a) go to materials and tests, b) review their personal information, or c) refer a colleague to these training materials.
4) When the user selects the “Go to Materials and Tests” option, s/he is presented with a list of the potential training programs. On this page the user is given the option to either overview or purchase (if there is a fee) the training materials.
5) If the user decides to review the materials, s/he clicks on the “overview” option and is directed to a synopsis of the training materials.
   If the potential user opts to purchase the materials they click on the “purchase” option and are directed to either the training materials or to an on-line (or other) payment system
   The potential user may opt to review and revise his/her own personal information instead of going directly to the “materials and tests” section.
6) If the user wishes to refer a colleague to the online training site, s/he clicks on the “refer a colleague” button and is directed another web page. The user has the option to enter in his/her own name on this page, his/her colleague's email address, and a personalized message to that colleague. The personalized message to the user's colleague may also contain a link and instructions showing the colleague how to access the online training materials.
7) When participants select the “option to purchase” selection they are informed that they will be required to pass the online exam with 75% accuracy to receive a certificate of completion. They are also informed that they will be allowed to retake the test a maximum of 2 times. On this page, they are given the opportunity to enter a case-sensitive electronic coupon that may provide them either with a dollar or a percentage discount towards the cost of the training if there is a fee. They are presented with a refund policy if there is a charge, a link for technical support, as well as other identifying information related to FFDE Facilitator 20. Further, when they select “click to continue” on this page they are presented with a page indicating the adjusted price of their final order if there is a fee charged. Next, they are directed to a secured online credit card processing service if there is a fee charged.
8) If there is a fee and the user opts to pay for the course, they may be directed to an on-line payment form or to another means of payment. Once payment is completed, the user is directed to the introduction section of the educational materials.

The user is required to answer a series of multiple choice questions after the reading the educational materials. These questions are used to assess the user's knowledge about the subject taught.
9) After the user completes the examination and training materials, s/he is presented with his/her test scores. At this time, they may also be offered the option of reviewing the educational materials, and/or re-taking the examination.
10) When the user has completed the entire examination with a passing score, s/he may receive his/her certificate of completion. Users who do not pass the examination are presented with information giving them the option to retake the test. Further, they are allowed a) to take a post-test survey to offer their comments about the examination, a) to print the online materials, c) to take another course, and d) to return to the FFDE Facilitator's 20 home page.
11) User feedback data are recorded and stored electronically.
12) To view data collected from the online examination, the FFDE Facilitator 20 enters a unique user code and password into the sign-in form of the online training materials. Then, the FFDE Facilitator 20 may view all information collected about individuals who have taken the test and training, including but not limited to name, address, email address and telephone numbers.
13) The FFDE Facilitator 20 also may select on an on-line “Reports” option. This option allows the FFDE Facilitator 20 to view reports about the users and other data. These reports are 1) Person/Test Passing, 2) Degree/Question, 3) Test Keys and 4) Post Test Feedback.
14) The “Person/Test Passing” link provides a comprehensive list of all users' names, highest degree, other degree, the test training program that they completed, the start date and completion dates of that or those exams, the number of questions completed, the number of questions answered correctly, and the percentage of questions answered correctly.
15) The “Degree/Question” link provides the total number of responses users have given to each test question in a given examination. It is possible to view these scores separately, or in any combination, for each classification of degreed individual who took the examination. For example, all of the responses to each test question can be viewed separately for licensed Ph.D. level psychologists or they may be combined with data from doctors possessing M.D. degrees.
16) When selecting the “Test Keys” option, the FFDE Facilitator 20 is presented with every question on the examination, and every potential response, with the correct responses highlighted.
17) After selecting the “Post Test Feedback” option, the FFDE Facilitator 20 is given the users' post-test assessments of the training/test materials, which may consist of numerical responses to rating scales, and/or written comments.
   Alternate Embodiments
   Other embodiments of the current invention include FFDE Facilitators 20 that do not:
1. have a licensed psychologist or physician directly oversee FFDEs
2. review/critique FFDE reports before they are sent to the employer
3. obtain accreditation by a regional or national professional and/or educational body to provide training to EAPs 50, insurers, employers 30, psychologists, and/or psychiatrists.
4. have a psychologist or psychiatrist offer to, and review potential referral 300 questions with, the employer 30 or EAP 50 client.
5. utilize an Internet website
6. utilize a computerized database with information about psychologists, psychiatrists, and other healthcare professionals
7. require Independent Examiners 80 to sign a contract with the FFDE Facilitator 20 formalizing a contractor/sub-contractor relationship between these two entities.
8. offer training in FFDE evaluation methods to individuals who desire training, but are not participating in any FFDE with the FFDE Facilitator 20
9. routinely arrange psychological testing, often with a second Independent Examiner 80
10. Schedule the FFDE appointments themselves.
11. formally review and critique Independent Examiner 80 draft reports before they are sent to the employer 30
12. Do not receive payment from the employer 30, but instead from the EAP 50 or another source.

Another method is to divide the responsibilities of the FFDE between different companies or entities. For example, one entity 150 could perform all FFDE functions except those that involve educational training for the EAP 50, employer 30, employee 40, and/or Independent Examiner 80. A second entity 150 could be primarily responsible for teaching and consulting with the EAP 50, employer 30, Independent Examiner 80, and employee 40. These activities could include teaching the a) Independent Examiner 80 how to perform an FFDE competently, b) employer 30 how to properly identify at risk employees 40 and phrase referral 300 questions, c) EAP 50 to recognize some at risk employees 40 requiring FFDE assessments, and d) employee 40 about privacy issues. Further, the second entity 150 could consult with the EAP 50, employer 30, Independent Examiner 80, and occasionally the employee 40, about other professional issues related to the FFDE.

Part B: How the Invention is of Benefit
1. Stone (2000) describes the current state-of-the art in his book (on FFDEs). In this text he describes FFDEs that are currently performed without a FFDE Facilitator 20. He indicates that there is a continual struggle between the involved parties that results from dual relationships.

As illustrated in the scenarios below, the FFDE Facilitator 20 prevents these dual relationships, and other problems, from occurring.

Scenario 1a (Current State of the Art): The Employer 30 Asks its Own Staff Doctor to Perform the FFDE

Consider what might happen when an employer 30 asks a doctor on its own staff to perform a FFDE. The staff doctor determines the employee 40 poses a risk to other employees 40, and consequently the employee 40 loses his job. What is to legally protect the employer 30 and the staff doctor if the dismissed employee 40 alleges that the doctor is biased, and is only concerned about the interests of their mutual employer 30? While convenient for the employer 30, this path offers limited protection from allegations of doctor dual relationships and is often considered to present a high level of risk for all concerned.

Scenario 2a (Current State of the Art): The Employer 30 Asks an Independent Examiner 80 to Perform the FFDE

When the employer 30 refers to an Independent Examiner 80, it takes one step towards promoting a fair and independent FFDE. Here, the employer 30 has less potential influence on the doctor than it would in the first scenario above. However, the perception might remain that the employer 30 might have prejudiced the doctor, because the employer 30 both selects and pays the Independent Examiner 80. Further, this model does not provide some benefits gained by the FFDE Facilitator's 20 quality control methods (such as taking out inappropriate medical information from the FFDE report).

Scenario 3a (Current State of the Art): The Employer 30 Asks an EAP 50 to Perform the FFDE with the EAP's 50 Staff Doctor

Imagine an employer 30 that asks its EAP 50 to have one of the EAP's 50 staff (or previously contracted) doctors perform the FFDE. As before, the doctor decides that an employee 40 poses a risk. Consequently, the employee 40 is terminated. The employer 30, having sought an independent opinion, is afforded some protection in this scenario. However, this scenario still leaves room to question the association between the EAP and the employer 30. This is due both to the direct nature of their relationship with each other and to the fact that the doctor was on the EAP's 50 staff.

While having the EAP 50 perform the FFDE may give some protection to the employee 40 and the employer 30, it can also introduce other problems. This is because employees 40 typically perceive the Employee 40 Assistance program's role as being an advocate of the employees 40, not employers 30. Further, some employees 40 worry that the EAP 50 crisis counselor could later use their personal information in a FFDE that could result in their termination.

Scenario 4a (Current State of the Art): The Employer 30 Refers to a Clinic that Performs the FFDE With its Own Staff Doctor

Here, an employer 30 refers the case directly to a clinic. The clinic then has one of its staff doctors perform the FFDE. While the employee 40 and employer 30 have some protection, there is still a relationship between the employer 30 and the clinic similar to that of an employer 30 using a staff doctor. Further, there is no separation between the clinic and its staff doctor. Consequently, while the employer 30 has some protection, the relationships still invite scrutiny. Also, there may be little assurance that the staff doctor has been appropriately credentialed to perform the FFDE, and other quality control methods may not be in place.

Scenario 5a (Current State of the Art): The Employer 30 Refers to an EAP 50 that Asks an External Independent Examiner 80 to Perform the FFDE

To further insulate the employee 40 from the employer 30, the external EAP 50 can have an Independent Examiner 80 perform the FFDE. Selecting an Independent Examiner 80 might reduce the EAP's 50 legal exposure, and the likelihood that employees 40 will perceive the EAP 50 as the employer's 30 advocate. This arrangement protects both the employer 30 and the employee 40 because there are two levels of separation between the employer 30 and the doctor who performs the FFDE. However, here the EAP 50 assumes risk, partly because it has a direct relationship with the Independent Examiner 80. Further, if the EAP 50 is to eventually treat the employee 40, in this arrangement the employee 40 might perceive the Independent Examiner 80 as a treating doctor.

Scenario 6a (Current State of the Art): The Employer 30 Refers to an EAP 50 Who Refers to a Clinic That Uses a Staff Doctor for the FFDE.

Here, the EAP 50 selects a clinic with special forensic evaluation services, which then has its own staff doctor conduct the FFDE. With this method, the EAP 50 is still at some risk, because it directly selected the clinic that did an internal FFDE using its own staff physician or psychologist. Such circumstances are also subject to scrutiny regarding that staff doctor's independence from the EAP 50.

Other Benefits of an FFDE Facilitator 20 Business Method Include:

1. Teaching and consulting with the employer 30 and EAP 50 helps these entities have reasonable expectations for the FFDE report and Independent Examiner 80.
2. Teaching and consulting with Independent Examiners 80 helps them perform reliable and valid examinations.
3. The database containing information about Independent Examiners 80 contains report ratings that are useful in educating the Independent Examiner 80, and for selecting examiners for future evaluations.
4. A professional with a MD or Ph.D. degree provides a higher level of consultative services throughout the FFDE process other than less-qualified individuals typically provide.
5. The FFDE Facilitator 20 has a marketing advantage over competitors with less desirable assessment/consultation methods.
6. FFDE results are provided in a standardized format, no matter where they are geographically located, thus promoting fairness and objectivity across evaluations.
7. The FFDE Facilitator 20 is able to quickly update standardized assessment protocols for future FFDEs.
8. A FFDE Facilitator 20 could become a licensable entity 150, with formal ethical rules/methods promoting advancement in the field of FFDE. Further, it provides a framework in which standard procedures can continually be enhanced and disseminated. As such, it provides a platform for shared intelligence and advancement.
9. Stone (2003, p. 134) notes that in rural settings treating doctors are asked to perform FFDEs on employees 40 that they had previously seen as patients. When this occurs, undesirable dual relationships are formed. The limited numbers of health care providers in rural (and other) areas who are trained to perform FFDEs causes this problem to occur with regularity. The FFDE Facilitator 20 however, is equipped to train (often rural) doctors to perform FFDEs, thus increasing the pool of potential Independent Examiners 80 free of dual relationships with particular employees 40, employers 30, and EAPs 50.
10. Most Independent Examiners 80, being businesses unto themselves, have unique payment, billing and cancellation policies. By using the FFDE Facilitator 20, employers 30 and EAPs 50 need not worry about idiosyncratic Independent Examiner 80 billing methods. The FFDE Facilitator 20 also reviews each bill to prevent reimbursement for unnecessary services, and may again negotiate fees with Independent Examiners 80.
11. Having a consistent and limited set of Independent Examiners 80 score and interpret psychological testing (for evaluations performed by a larger group of Independent Examiners 80 nationwide) provides more consistency in the quality of test scoring and interpretations. Further, the limited numbers of Independent Examiners 80 who score and interpret the psychological testing permits the FFDE Facilitator 20 to easily train those Independent Examiners 80 about issues ranging from test administration, transmission of report data, to test interpretation. Consistently having testing performed by a limited set of Independent Examiners 80 allows the FFDE Facilitator 20 to negotiate lower fees with this group of (testing) Independent Examiners 80.
13. A FFDE Facilitator 20 fairly addresses the concerns of all involved parties.
14. A FFDE Facilitator 20 oversees FFDEs, which are an alternative to disciplinary procedures.

Part C: Extensions
a. Pre-employment physical, psychological and Psychiatric screenings. These are evaluations that occur before an offer of employment is made to a prospective employee 40. FFDE methods could be used to screen potential employees 40. Employers 30 would request the examinations. The FFDE Facilitator 20, or a similar entity 150, would create relationships with employers 30 similar to those it now creates with employers 30 when performing an examination in the current embodiment. The FFDE Facilitator 20 or similar entity 150 would establish relationships with the potential employees 40 similar to those it now establishes with employees 40 in the current FFDE Facilitator 20 embodiment. It is unlikely that an EAP 50 would be directly involved in any way with this assessment process. Independent Examiners 80 would perform the pre-employment physical, psychological and/or psychiatric screenings.
b. Employment physical, psychological and Psychiatric pre-placement screenings. These evaluations occur after an employee 40 is hired, but before s/he is assigned specific tasks or to a specific job within an organization. FFDE methods could be used to assist in determining the specific or general tasks that employees 40 are suited, able or motivated to perform. Employers 30 would request the examinations. The FFDE Facilitator 20, or similar entity 150, would create relationships with employers 30 similar to those it creates with employers 30 when performing an examination in the current embodiment. The FFDE Facilitator 20 or similar entity 150 would establish relationships with the employees 40 similar to those it now establishes with employees 40 in the FFDE Facilitator 20 current embodiment. It is unlikely that an EAP 50 would be directly involved with the assessment process. Independent Examiners 80 would perform the evaluations regarding physical or psychiatric/psychological issues.
c. Workplace crisis intervention assessments. FFDE Facilitator 20 or similar entities could formulate responses to workplace crises. Employers 30 would request the examinations. The FFDE Facilitator 20 or similar entity 150 would create relationships with employers 30 similar to those it now creates with employers 30 when performing a FFDE in the current embodiment. The FFDE Facilitator 20 or similar entity 150 would establish relationships with the employees 40 similar to those it establishes with employees 40 in the FFDE Facilitator 20 current embodiment. It is likely that an EAP 50 would be directly involved with the assessment process in a manner similar to the role that the FFDE Facilitator 20 assumes in the current FFDE Facilitator 20 embodiment. Independent Examiners 80 would perform the evaluations. Here the FFDE Facilitator 20 could also teach employers 30 how to recognize when to seek the assistance of a FFDE Facilitator 20.
d. Workplace dispute resolution. FFDE methods could be used to resolve workplace disputes. Employers 30 would request the examinations/consultation services. The FFDE Facilitator 20 or similar entity 150 would create relationships with employers 30 similar to those it now creates with employers 30 when performing a FFDE in the current embodiment. The FFDE Facilitator 20 or similar entity 150 would establish relationships with the employees 40 similar to those it now establishes with employees 40 in the FFDE Facilitator 20 current embodiment. It is likely that an EAP 50 would be directly involved with the FFDE process, in a manner similar to the role it assumes in the current FFDE Facilitator 20 embodiment. Independent Examiners 80 would perform the evaluations.
e. FFDEs of individuals working in volunteer positions. Volunteer organizations would request the FFDEs. The FFDE Facilitator 20 would create relationships with them similar to those it creates with employers 30 when evaluating employer's 30 employees 40 in the current FFDE embodiment. The FFDE Facilitator 20 would establish relationships with the volunteer that would be similar to those it now establishes with employees 40, in the current FFDE Facilitator 20 embodiment. It is unlikely that an EAP 50 would be involved with the FFDE. Independent Examiners 80 would perform the evaluations.
f. Examinations of students at all educational levels. School districts, school administration, or other governmental agencies would request the examinations. The FFDE Facilitator 20 or similar entity 150 would create relationships with them similar to those it creates with employers 30 when evaluating employer's 30 employees 40 in the current FFDE embodiment. However, in this scenario minor student's parents or guardians would be additional participants in the assessment process. The FFDE Facilitator 20 or similar entity 150 would establish relationships with the child that would be similar to those it now establishes with employees 40, in the current FFDE Facilitator 20 embodiment. An EAP 50 does not need to be involved with the evaluation. Independent Examiners 80 would perform the evaluations.
g. FFDEs of military personnel. Governmental officials and military personnel would request the FFDEs. The FFDE Facilitator 20 or similar entity 150 would create relationships with them similar to those created with employers 30 in the current FFDE Facilitator 20 embodiment. The FFDE Facilitator 20 or similar entity 150 would establish relationships with the evaluated military personnel similar to those it now establishes with employees 40, in the current FFDE Facilitator 20 embodiment. It is possible that an EAP 50 or another governmental organization would be involved with the FFDE process, in a manner similar to the role such organizations assume in the current FFDE Facilitator 20 embodiment. Independent Examiners 80 would be preferred to perform the evaluations.
h. FFDEs of business owners. Business partners, business owners, the courts, or others would request the FFDEs. The FFDE Facilitator 20 or similar entity 150 would create relationships with these referral 300 sources similar to those established in the current FFDE Facilitator 20 embodiment. The FFDE Facilitator 20 or similar entity 150 would establish relationships with the evaluated business owners similar to those it now establishes with employees 40 in the FFDE Facilitator 20 current FFDE embodiment. It is possible that an EAP 50 would be involved with the FFDE process, in a manner similar to the role it assumes in the current FFDE Facilitator 20 embodiment. Independent Examiners 80 would perform the evaluations.
i. FFDEs of government officials. These would occur at the request of other government officials or government entities. The FFDE Facilitator 20 would create relationships with these referral 300 sources similar to those it creates with employers 30 in the current FFDE Facilitator 20 embodiment. The FFDE Facilitator 20 would establish relationships with the evaluated government officials similar to those it now establishes with employees 40, in the current FFDE Facilitator 20 embodiment. It is possible that an EAP 50 or another similar governmental organization would be involved with the FFDE process, in a manner similar to the role such entities (e.g. EAPs 50) assume in the current FFDE Facilitator 20 embodiment. Independent Examiners 80 would perform the evaluations.
j. Evaluations for court systems on defendants and convicted criminals. FFDE procedures could be easily adapted to perform these evaluations as they would be requested by attorneys or judges. In this scenario the referring court system or attorney would fulfill a role similar to the employer's 30 role in the current embodiment of a FFDE Facilitator 20. The FFDE Facilitator 20 or similar entity 150 would establish relationships with the evaluated criminals and defendants similar to those it now establishes with employees 40, in the current embodiment. Independent Examiners 80 would perform the evaluations.
k. Independent Medical Examinations for disability, worker's compensation, automobile liability, cases. In this application/scenario the referring insurance company would fulfill a role similar to the employer's 30 role in the current embodiment of a FFDE Facilitator 20. The FFDE Facilitator 20 or a similar entity 150 would establish relationships with the evaluated disability, worker's compensation, and automobile liability etc claimants similar to those it now establishes with employees 40, in the current FFDE Facilitator 20 embodiment. Independent Examiners 80 would perform the evaluations.
l. Evaluations of parents and other family members involved in custody suits. FFDE procedures could be easily adapted to perform these evaluations as they would be requested by litigants, attorneys or judges. In this scenario the referring litigant, court system or attorney would fulfill a role similar to the employer's 30 role in the current embodiment of a FFDE Facilitator 20. The FFDE Facilitator 20 or similar entity 150 would establish relationships with the evaluated parties similar to those it now establishes with employees 40, in the current embodiment. Independent Examiners 80 would perform the evaluations.

In view of the foregoing disclosure, some advantages of the present invention can be seen. For example, a novel method of determining fitness for duty is provided. The novel method utilizes a FFDE Facilitator 20 that offers advanced professional training to Independent Examiners 80, employers 30, EAPs 50 and doctors regarding FFDE methods, while protecting all parties by insulating them from each other.

While the preferred embodiment of the present invention has been described and illustrated, modifications may be made by one of ordinary skill in the art without departing from the scope and spirit of the invention as defined in the appended claims.

1. A method for evaluating the fitness for duty of an employee, utilizing as parties an employer, Independent Examiner and a fitness for duty evaluation facilitator, comprising the steps of:
requiring the Independent Examiner to have competence in fitness for duty assessment;
offering the employer an accredited fitness for duty evaluation training program;
ensuring that the Independent Examiner follows standardized assessment protocols;
insulating the employer, the employee, and the Independent Examiner from each other; and
providing a fitness for duty evaluation facilitator to consult with the Independent Examiner and the employer.

2. The method of claim 1, wherein the step of ensuring that the Independent Examiner follows standardized assessment protocols comprises providing fitness for duty evaluation training to the Independent Examiner.

3. The method of claim 1, wherein the fitness for duty evaluation facilitator selects, pays, and supervises the Independent Examiner.

4. The method of claim 1, wherein an employer-paid professional or organization provides health care assistance to the employer or the employee.

5. The method of claim 4 wherein contact between the employer-paid professional or organization and the employee is limited and mediated.

6. The method of claim 5 wherein the fitness for duty evaluation facilitator mediates contact between the Independent Examiner and the employer or the employer-paid professional or organization.

7. The method of claim 1, further comprising the step of offering an employer-paid professional or organization an accredited fitness for duty evaluation training program.

8. A method for evaluating the fitness for duty of an employee, utilizing as parties an employer, fitness for duty evaluation facilitator and Independent Examiner, comprising the steps of the fitness for duty evaluation facilitator:
teaching the Independent Examiner how to perform a fitness for duty evaluation consistent with professional standards of practice;
offering an accredited fitness for duty evaluation training program;
phrasing with the employer one or more referral questions; and
teaching an employer-paid professional or organization to recognize situations that warrant fitness for duty evaluation.

9. The method of claim 8, further comprising the step of the fitness for duty evaluation facilitator consulting with the employer and the Independent Examiner about professional issues related to the fitness for duty evaluation.

10. The method of claim 8, further comprising the step of teaching an employee about professional functions in a fitness for duty evaluation.

11. The method of claim 8 further comprising the step of consulting with an employer-paid professional or organization on the appropriateness of a fitness for duty examination of an employee.

12. The method of claim 8 further comprising the step of teaching an employer-paid professional or organization how to arrange a fitness for duty examination that is consistent with professional standards of practice.

13. A method for evaluating the fitness for duty of an employee, utilizing as parties an employer, Independent Examiner, employer-paid professional or organization and a fitness for duty evaluation facilitator, comprising the steps of the fitness for duty evaluation facilitator:
having ownership separate from the employer and the employer-paid professional or organization;
engaging the Independent Examiner to perform the fitness for duty evaluation;
offering an accredited fitness for duty evaluation training program; and
providing quality assurance services.

14. The method of claim 13, further comprising providing accredited advanced training in performing fitness for duty evaluations to the Independent Examiner.

15. The method of claim 14, wherein the step of providing the advanced training to the Independent Examiner includes utilizing written, verbal, or visual training.

16. The method of claim 15, wherein the step of providing the advanced training to the Independent Examiner utilizing written, verbal, or visual training further includes providing the advanced training on-line, by telephone, video conference, in-person discussions, or educational conferences.

17. The method of claim 13, wherein the step of providing quality assurance services comprises utilizing a licensed psychologist or psychiatrist.

18. The method of claim 13, wherein the step of providing quality assurance services comprises utilizing a licensed psychologist or psychiatrist to oversee the fitness for duty evaluation.
